(19) United States
(12) Patent Application Publication
(10) Pub. No.: US 2009/0255738 A1
(43) Pub. Date: Oct. 15, 2009

(54) TOWING DEVICE AND SYSTEM

(76) Inventor: Hagai Jacob Cohen, Rishon le'zion (IL)

Correspondence Address: MERCHANT & GOULD PC, P.O. BOX 2903, MINNEAPOLIS, MN, 55402-0903, US

(21) Appl. No.: 12/421,019

(22) Filed: Apr. 9, 2009

Related U.S. Application Data
(60) Provisional application No. 61/043,409, filed on Apr. 9, 2008.

(51) Int. Cl. B62D 51/04

(52) U.S. Cl. 180/19.3

(57) ABSTRACT

A towing device for towing of a carrier that enables carrying at least one user, wherein the user drives and steers the towing device, includes a front part and at least one steering-element. The front part of the towing device includes a motor and engagement-means wherein the motor is operatively associated with the engagement-means and the engagement-means allow driving the towing device upon a road. The at least one steering-element is operatively coupled to the front part of the towing device in a rotatable manner, enabling to operate and control the motor and to change the angular position of the front part in relation to the at least one steering-element thereby to turn the towed carrier angularly, in relation to the front part.

### CROSS REFERENCE TO RELATED APPLICATIONS

This application claims the benefit of U.S. Provisional Patent Application Ser. No. 61/043,409, filed Apr. 9, 2008, which application is hereby incorporated by reference in its entirety.

### FIELD OF THE INVENTION

The present invention relates generally to the field of vehicle devices and more particularly to towing vehicles and devices.

### BACKGROUND OF THE INVENTION

Motorized towing vehicles for sportive activities (such as for towing a rollerblades skater or a ski-surfer) become increasingly popular in recent years allowing users to practice extreme sports while using the advantages of the motorized traction.

Although these vehicles allow pulling or towing the user and carriers (e.g. rollerblades), these vehicles' steering means are usually connected to the wheels of the vehicle and force the user and steering means to be set at the same angular position in relation to one another.

When the user wishes to make a curved turn, the entire vehicle (as long and as heavy as it may be) may be forced to tilt in the direction of the gravitational force turning the vehicle as a single piece.

Additionally, in these towing vehicles the user is often required to turn the motor of the vehicle on and then hold the steering means of the vehicle without allowing the user to control the motor or the braking systems of the vehicle while still holding the steer.

### SUMMARY OF THE INVENTION

According to one aspect of the disclosure, a towing device for towing of a carrier that enables carrying at least one user, wherein said user drives and steers said towing device, is disclosed. Said towing device comprises a front part and at least one steering-element, wherein said front part comprises a motor and engagement-means wherein said motor is operatively associated with said engagement-means and said engagement-means allow driving said towing device upon a road. Said at least one steering-element is operatively coupled to said front part in a rotatable manner, enabling to operate and control said motor and to change the angular position of said front part in relation to said at least one steering-element thereby to turn said towed carrier angularly, in relation to said front part. A towing system comprising a towing device and a carrier that enables carrying at least one user, wherein said user is carried by said carrier and drives said towing device, is also disclosed.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is an isometric view, which schematically illustrates a towing system comprising a towing device, according to some embodiments of the invention; and

FIG. 2 is an isometric view, which schematically illustrates the bearings associating steering-elements of the towing device with a main-bar, according to some embodiments of the invention.

The drawings together with the description make apparent to those skilled in the art how the invention may be embodied in practice.

### DETAILED DESCRIPTION OF THE PREFERRED EMBODIMENT

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The present invention, in some embodiments thereof, discloses a towing system 1000 and a towing device 100 for towing at least one user 10 that is carried by a carrier 200 such as a skateboard, bicycle, rollerblades, a sled, a wheeled carriage and the like.

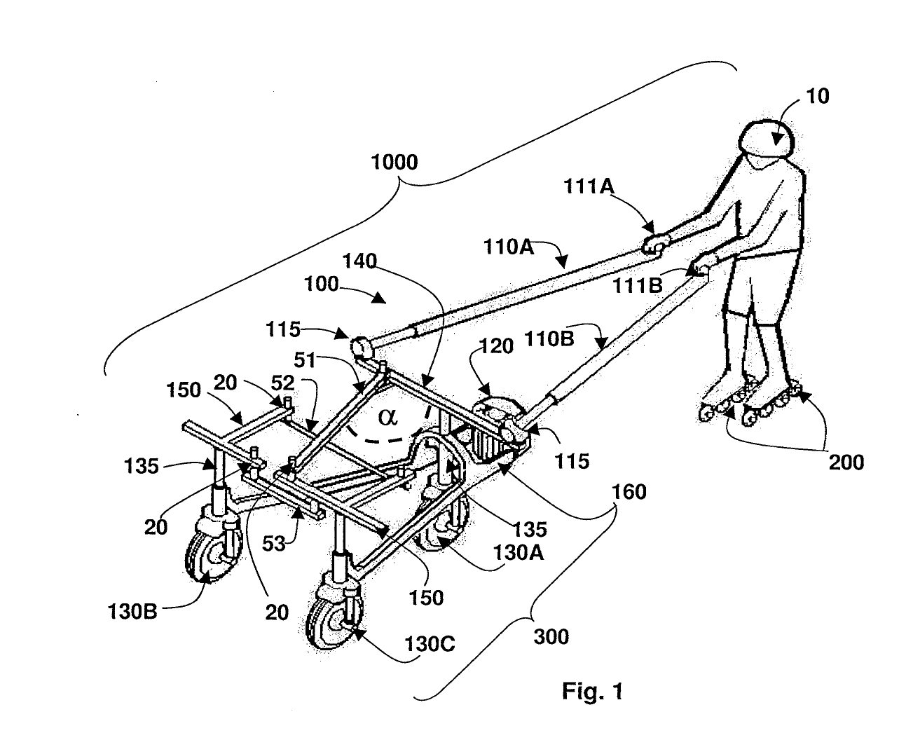

According to some embodiments of the invention, as illustrated in FIG. 1, the towing system 1000 may comprise the towing device 100 and the carrier 200. The towing device 100 may be coupled to the carrier 200 through any coupling means such as through connecting elements (not shown) or through the user 10 (see FIG. 1).

As illustrated in FIG. 1, the user 10 may hold one or more steering-elements 110A and 110B enabling the user 10 to steer and drive the towing device 100 while being supported by the carrier 200.

According to some embodiments of the invention, as illustrated in FIG. 1, the towing device 100 may comprise a front part 300 and at least one steering-element 110A and 110B. The front part 300 may comprise a motor 120 and engagement-means 130 (e.g. wheels or sled runners) where the motor 120 is operatively associated with the engagement-means 130 and the engagement-means 130 allow driving and steering the towing device 100 upon a surface (e.g. a land road, snow or any other surface).

The steering-elements 110A and 110B may be operatively coupled to the front part 300 in a rotatable manner enabling to operate and control the motor 120 of the towing device 100 and to change the angular position (e.g. the angle “α”) of the front part 300 in relation to the steering-elements 110A and 110B, thereby to turn the towed carrier 200 angularly, in relation to the front part 300.

This may be most efficient for turning curved parts of a road with the towing device 100 when driving it, allowing a smaller curve angle “a” to be used for turning the curve of the surface (e.g. road).

According to some embodiments of the invention, as illustrated in FIG. 1, the towing device 100 may comprise:
one or more steering elements 110A and 110B, which may be two rods with corresponding handles 111A and 111B;
a main-bar 140;
a chassis 160, which may be a triangular base frame;
a motor 120;
one or more engagement-means 130A, 130B and 130C, which may be wheels or sky/water runners, for example;
one or more bars 150.

The steering-elements 110A and 110B may be operatively connected to the main-bar 140; the main-bar 140 may be operatively connected to the bars 150, where the main-bar 140 and bars 150 may be operatively connected to the engagements-means 130A, 130B and 130C through the chassis 160 and through other connecting means 135, and to the motor 120.

The chassis 160 may support the weight of the motor 120. The motor 120 may be operatively associated with the steering-elements 110A and 110B and with at least one of the engagement-means 130A, 130B and 130C enabling to operate and control the motor 120 and the engagements-means 130A, 130B and 130C according to the user's 10 moving of the steering-elements 110A and 110B.

The motor 120 may enable generating enough power to create a traction allowing the towing device 100 to advance as well as to tow the carrier 200 and at least one passenger and/deriver referred to hereinafter as user 10. The type, volume, and power of the motor 120 may be predefined according to the towing system's 1000 requirements, size and design as well as according to the number of passengers or users 10 that can use the system 1000 and that can be towed thereby.

According to some embodiments of the invention, as illustrated in FIG. 1, the handles 111A and 111B may allow a user to hold and direct the steering-elements 110A and 110B and thereby steer the towing device 100.

According to some embodiments of the invention, each edge of the main-bar 140 may be connected to an edge of one of the steering-elements 110 via at least one bearing 115 enabling to move the steering-elements 110A and 110B and operate and control various driving functions such as changing gears, controlling the fuel and brakes of the towing device 100 etc.

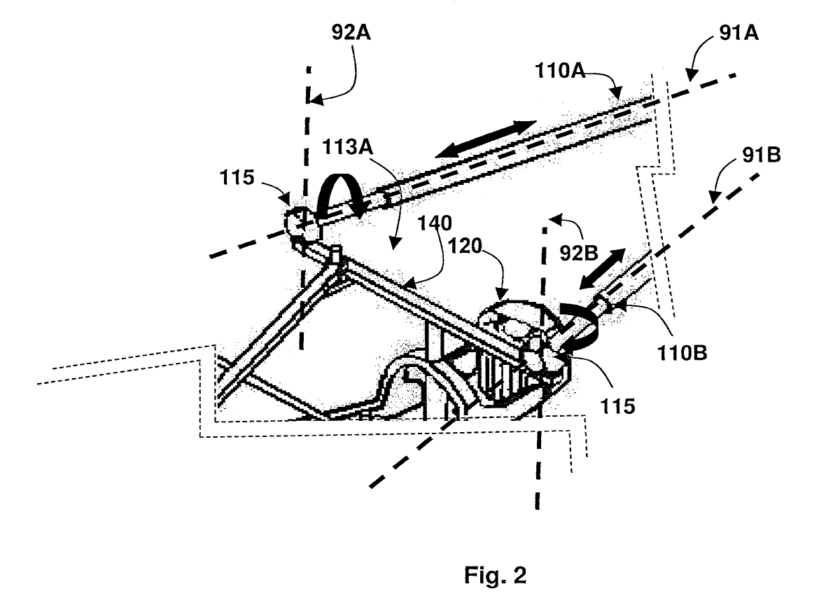

According to some embodiments of the invention, as illustrated in FIG. 2, the bearings 115 may allow moving each steering-element of 110A and 110B in at least one of:
A. a longitudinal movement along an axis 91A or 91B that is parallel to the corresponding steering-element 110A or 110B
B. a rotational movement of each steering element 110A or 110B around the corresponding first axis 91A or 91B; and
C. a tilting movement of each steering element 110A or 110B around a corresponding central point that is the crossing point of the corresponding first axis 91A with a second axis 92A or first axis 91B with a second axis 92B, which is perpendicular to the first axis 91A or 91B.

According to some embodiments of the invention, the rotation and/or the tilting of each steering-element 110A and 110B may operate and/or control driving functions and operations such as (i) starting/shutting of the motor 120 (turning it on/off); (ii) controlling the speed and acceleration of the towing device 100 (e.g. by controlling fuel or gas flow); (iii) controlling braking-means (not shown) enabling to slow down or completely stop the advancing of the towing device 100 by allowing to operate the braking-means and controlling their braking intensity; and the like.

According to some embodiments of the invention, as illustrated in FIG. 1, the main-bar 140 may be connected to one of the front bars 150 through a first connector 51, which may be a rod like shape, where one edge of the first connector 51 is connected to the main-bar 140 through any means such as joints 20 and the other edge of the first connector 51 is connected to one of the bars 150 via another joint 20.

According to some embodiments of the invention, as illustrated in FIG. 1, the bars 150 may be connected to the front engagement-means 130B and 130C via the connecting-means 135. Additionally, the bars 150 may be connected to one another via second and third connectors 52 and 53 connected to each bar 150 via joints 20.

The connections between the bars 150 may allow keeping both bars 150 substantially aligned to one another according to their initial predefined alignment relation. The main-bar 140 may move in relation to the first connector 51 therefore in relation to the bars 150 and their connected engagement-means 130B and 130C. This may allow the front part 300 of the towing device 100 comprising the bars 150 and engagement-means 130B and 130C to move angularly in relation to the steering-elements 110A and 110B and the carrier 200. This may be extremely useful when turning curved road-parts such as corners with the device 100, especially when used as a sports vehicle (e.g. for races etc.).

To turn the front part 300 of the towing device 100 in an angle α<90° in relation to at least one of the steering-elements 110A and 110B (and therefore in an angle α<90° in relation to the carrier 200), the user 10 may push or pull the steering-elements 110A and 110B in a longitudinal direction (in relation to the axes 91A and 91B of the steering-elements 110A and 110B) thereby change the angular position of the main-bar 140 in relation to each of the steering-elements 110A and 110B. The main-bar 140 may consequently push or pull one of the bars 150, which is connected to the main-bar 140 thereby create an angle α<90° between the front part 300 of the towing device 100 and the steering-elements 110A and 110B.

According to some embodiments of the invention, the third connectors 53 may be made from elastic materials or constructions (e.g. a spring) allowing each bar 150 and its corresponding engagement-means 130B and 130C to slightly divert from their alignment, where each bar 150 allows absorbing shocks by enabling to move in a slightly different manner than the other bar 150.

According to some embodiments of the invention, one of the steering-elements (e.g. steering-element 110A) may also serve as a fuel-regulator (e.g. as a gas-handle) enabling the user 10 to control the fuel throttle by rotating the steering-element 110A. Accordingly, the other steering-element 110B, may serve as a brakes-regulator enabling the user 10 to operate the braking means (not shown) by rotating of the steering-element 110B.

According to some embodiments of the invention, the towing device 100 may additionally comprise a housing (not shown) that may be supported by the chassis 160. The housing may cover at least some of the bars and connectors of the front part 300 of the towing device 100 and serve as a decorative part and/or as a protective part e.g. protecting the towing device 100 from damages such as sand, stones or other dirt-particles that may damage the motor 120 or engagement-means 130A, 130B and/or 130C.

According to some embodiments of the invention, the motor 120 may be either automatic, semi-automatic or gear based, as known in the art.

According to some embodiments of the invention, the towing system 1000 may be used for (i) road rolling—where the engagement-means 130A, 130B and 130C are wheels that can roll over a road surface and where the carrier 200 also comprises one or more wheels (e.g. rollerblades, bicycle, carriage); (ii) snow ski—where the engagement-means 130A, 130B and 130C are either a sled or ski runners; and (iii) water ski—where the engagement-means 130A, 130B and 130C are either a water sled or water-ski runners.

According to some embodiments of the invention, the weight of the chassis 160, the engagement-means 130A, 130B and 130C and the motor 120 may be sufficient to keep the engagement-means 130A, 130B and 130C substantially on the surface level, which may either be a road, the surface of the sea (if the device 100 has water-ski runner as engagement-means) or snow (if the device 100 has snow-ski runner as engagement-means).

The center of weight of the towing device 100 as well as shock observers (not shown) that may be installed in the device 100 may serve as additional shock preventing means enabling to absorb shocks.

At least some of the joints 20 may be bearings allowing various rotational or tilting movements of the connectors and/or bars.

According to some embodiments of the invention, the steering-elements 110 may be telescopic allowing the user to adjust the length of each steering element 110 to fold the steering-elements 110 against the front part 300 to allow easy and compact storage of the towing device 100.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A towing device 100 for towing of a carrier 200 that enables carrying at least one user 10, wherein said user 10 drives and steers said towing device 100, said towing device 100 comprising a front part 300 and at least one steering-element 110, wherein said front part 300 comprises a motor 120 and engagement-means 130 wherein said motor 120 is operatively associated with said engagement-means 130 and said engagement-means 130 allow driving said towing device 100 upon a road;
wherein said at least one steering-element 110 is operatively coupled to said front part 300 in a rotatable manner, enabling to operate and control said motor 120 and to change the angular position of said front part 300 in relation to said at least one steering-element 110 thereby to turn said towed carrier 200 angularly, in relation to said front part 300.

2. A towing system 1000 comprising a towing device 100 and a carrier 200 that enables carrying at least one user 10, wherein said user 10 is carried by said carrier 200 and drives said towing device 100,
said towing device 100 comprising a front part 300 and at least one steering-element 110, wherein said front part 300 comprises a motor 120 and engagement-means 130 wherein said motor 120 is operatively associated with said engagement-means 130 and said engagement-means 130 allow driving said towing device 100 upon a road;
wherein said at least one steering-element 110 is operatively coupled to said front part 300 enabling to operate and control said motor 120 and to change the angular position of said front part 300 in relation to said at least one steering-element 110 thereby to turn said towed carrier 200 angularly, in relation to said front part 300.
